(19) United States
(12) Patent Application Publication
(10) Pub. No.: US 2018/0340278 A1
(43) Pub. Date: Nov. 29, 2018

(54) FUNCTIONAL SHEET

(71) Applicant: Sung-Mo JUNG, Jeollanam-do (KR)

(72) Inventor: Sung-Mo JUNG, Jeollanam-do (KR)

(21) Appl. No.: 15/757,827

(22) PCT Filed: Sep. 6, 2016
(86) PCT No.: PCT/KR2016/009985

§ 371 Date: Mar. 6, 2018

(30) Foreign Application Priority Data
Sep. 7, 2015 (KR) 10-2015-0126553

(51) Int. Cl. D04H 1/46; A01G 13/02; E01H 11/00; E02D 3/00; E04B 1/62; E04B 1/99; D06C 23/04; D04H 1/4291

(52) U.S. Cl. CPC D04H 1/46; A01G 13/0268; E01H 11/00; E02D 3/00; E04B 1/625; D10B 2401/02; D06C 23/04; D04H 1/4291; D10B 2321/021; D10B 2321/022; D10B 2505/204; E04B 1/99

(57) ABSTRACT

A functional sheet manufactured with staple fibers is provided. More particularly, a functional sheet is formed as a single layer or a composite layer by binding polyolefin staple fibers by needle punching, to enhance physical properties of the functional sheet so that the functional sheet may be used for various purposes, for example, for weed growth prevention, waterproofing, soundproofing, ground stabilization, civil engineering, construction and aging-friendly materials.

### CROSS-REFERENCE TO RELATED APPLICATION

This application claims priority under 35 U.S.C. § 119(a) of Korean Patent Application No. 10-2015-0126553, filed on Sep. 7, 2015, in the Korean Intellectual Property Office, the entire disclosure of which is incorporated herein by reference.

### BACKGROUND OF THE INVENTION

### 1. Field of the Invention

The present invention relates to a functional sheet manufactured with staple fibers, and more particularly, to a functional sheet formed as a single layer or a composite layer by binding polyolefin staple fibers by needle punching, to enhance the physical properties of the functional sheet so that the functional sheet may be used for various purposes, for example, for weed growth prevention, waterproofing, soundproofing, ground stabilization, civil engineering, construction and aging-friendly materials.

### 2. Description of Related Art

Anti-weed film materials according to a related art have been mainly used to inhibit a growth of weeds in soil in which crops are planted. Such film materials enable weeds to be easily removed with a low labor force so as to suppress a growth of weeds. However, it has inconvenience to peel off a film when water is added to crops due to insufficient air permeability and drainability. Also, since an oxygen supply to the soil is interrupted due to the film and microbial cultivation is inhibited, the soil becomes acidified, which leads to a slowdown of in the growth of crops. In addition, it is difficult to reuse the film due to a denaturation of the film by ultraviolet rays, and a secondary contamination due to a waste film may also occur.

Currently, in the Korean peninsula, the south coast is a wet-subtropical climate region, which has a high temperature and humidity in the summer, and the rest of the country has a continental climate. Due to the effects of global warming, most parts of South Korea except the mountains are expected to change to subtropical climate regions. Thus, due to a growth activity of weeds, torrential rain and a climate of high temperature and humidity, many issues such as environmental damage, traffic accidents, ground subsidence, or a loss of a road in a construction and civil engineering field, may be caused by weeds, torrential rains or external forces, and may occur around a road such as a highway, a national highway and a local road, a sidewalk block and a shoulder of a road as well as a farmland.

Accordingly, to solve the above issues according to the related art, various methods are being tried. For example, Korean Patent Application No. 10-2006-0106979 discloses a mat for preventing weed growth that includes a hygroscopic layer that has a good hygroscopic property and that is formed of crushed waste fabrics, a pored layer that is formed with pores to prevent moisture from evaporating from the hygroscopic layer, and a surface layer that is bound onto the pored layer, that is heat-treated to smooth a top surface, that is formed by mixing 50% by weight (wt %) to 80 wt % of polyethylene terephthalate, 10 wt % to 30 wt % of polypropylene and 10 wt % to 20 wt % of polyethylene to prevent a growth of weeds due to an absence of a hygroscopic property, and that has a heat-treated upper surface. Each of the above layers is bound through a punching process using a needle punching machine.

However, a productivity of the mat formed by binding at least three types of materials, for example, the hygroscopic layer, the pored layer and a heat-treated sheet through needle punching is greatly reduced, and significant manufacturing costs are required. Also, since an air permeability and water permeability are poor, the soil is impoverished.

Also, Korean Patent Application No. 10-2009-0012472 discloses a needle punching nonwoven fabric for weeding formed as a nonwoven fabric by binding polyester staple fibers by needle punching. The polyester staple fibers are prepared by mixing 25 wt % to 50 wt % of polyester staple fibers with a denier value of 6 to 10, 10 wt % to 30 wt % of polyester staple fibers with a denier value of 16 to 20 and polyester staple fibers with a denier value of 11 to 15, and are bound by needle punching.

However, a drying process is necessarily required in a process of manufacturing the needle punching nonwoven fabric by mixing and binding at least three types of polyester staple fibers by needle punching, due to the moisture absorption phenomenon of a polyester resin used as a material of a staple fiber, and a durability is reduced due to a promotion of a hydrolysis due to a weak water resistance of the polyester resin.

In addition, Korean Patent Application No. 10-2011-7030896 discloses a nonwoven fabric with an uneven surface structure. On at least one surface of the nonwoven fabric in which a bridge point between fibers is heat-bonded by passing hot wind through a web including a heat-bondable fiber, a surface shape with a plurality of pores is pressed. Such a pressing treatment is performed in a state in which the nonwoven fabric has heat that does not perform heat bonding of the nonwoven fabric.

However, since the nonwoven fabric with the uneven surface structure is provided to be used for hygiene materials such as disposable diapers, wiping cloths, and the like, the tensile strength, the tensile elongation, and the durability are insufficient to be used for ground stabilization such as prevention of weed growth, civil engineering or construction.

### SUMMARY OF THE INVENTION

### Technical Subjects

Example embodiments of the present invention provide a functional sheet manufactured as a single layer or a composite layer by binding polyolefin staple fibers through a needle punching process, to enhance the physical properties of the functional sheet, for example, the tensile strength, the tensile elongation, water permeability, air permeability, and durability.

In particular, example embodiments of the present invention provide a functional sheet that may be excellent in its ability to prevent soil loss, prevent acidification and inhibit the growth of weeds, and that may maintain resilience which in turn may prevent soil pollution.

Also, example embodiments of the present invention provide a highly functional sheet that has a surface on which a plurality of uneven structures are formed using polyolefin staple fibers, and that is applicable for various purposes, for example, for waterproofing, soundproofing, ground stabilization, civil engineering, construction and aging-friendly materials, simplifying the manufacturing process and to lower manufacturing costs.

### Technical Solutions

According to an aspect of the present invention, there is provided a functional sheet manufactured with staple fibers that are polyolefin staple fibers, and the functional sheet is formed as a single layer or a composite layer by binding the polyolefin staple fibers by needle punching.

Desirably, there is provided a functional sheet that has a plurality of uneven structures formed on at least one surface of the functional sheet, and that is applicable for weed growth prevention, waterproofing, soundproofing, ground stabilization, civil engineering, construction and aging-friendly materials.

Desirably, the polyolefin staple fibers may include one of a polyethylene staple fiber, a polypropylene staple fiber and a polybutylene staple fiber, or a mixture of two or more thereof, and the difference in height between a convex portion and a neighboring concave portion of an uneven structure may be in a range from 0.5 mm to 8 mm.

Desirably, a top area of the convex portion may be in a range from 0.5 mm² to 6 mm², the total of the top areas of the convex portions may be 30% to 70% of the area of the functional sheet on which the convex portions are formed, and a convex portion or a concave portion of the uneven structure may have a “ [symbol] ” shape or a “ [symbol] ” shape.

A valley may desirably be formed in a convex portion or a concave portion of the uneven structure.

The functional sheet may desirably have a weight per unit area of 30 g/m² to 600 g/m², and a maximum thickness of 0.5 mm to 10 mm.

### Effect of the Invention

According to example embodiments of the present invention, a functional sheet may be manufactured as a single layer or a composite layer by binding polyolefin staple fibers by needle punching, to enhance the physical properties such as tensile strength, tensile elongation, water permeability, air permeability and durability, so that the functional sheet may be used for various purposes, for example, for waterproofing, soundproofing, ground stabilization, civil engineering, construction and aging-friendly materials.

In particular, according to example embodiments of the present invention, a functional sheet may be formed as a single layer or a composite layer by binding polyolefin staple fibers by needle punching, and may have a plurality of uneven structures formed on at least one surface of the functional sheet, to enhance tensile strength, tensile elongation, water permeability, air permeability and durability, and thus it is possible to have an excellent ability to prevent soil loss, prevent acidification and inhibit the growth of weeds, and have an effect to maintain the resilience of soil and prevent soil pollution.

Also, according to example embodiments of the present invention, a functional sheet may be manufactured as a sheet of a single layer or a composite layer with a surface on which an uneven structure is formed, and thus it is possible to simplify a manufacturing process and to lower manufacturing costs.

### BRIEF DESCRIPTION OF THE DRAWINGS

FIG. 1 is a cross-sectional view of a functional sheet according to an example embodiment of the present invention.

FIG. 2 is a flowchart illustrating a method of manufacturing a functional sheet according to an example embodiment of the present invention.

FIG. 3 is a diagram illustrating a needle punching process in a method of manufacturing a functional sheet according to an example embodiment of the present invention.

FIG. 4 is a diagram illustrating a formation of an uneven structure in a method of manufacturing a functional sheet according to an example embodiment of the present invention.

[Explanation of reference numerals]

| | |
|---|---|
| 10: Convex portion | 20: Concave portion |
| 30: Needle | 40: Web |
| 50: Uneven drum | 60: Flat drum |
| 70: Drum convex portion | 80: Drum concave portion |

### DESCRIPTION OF THE PREFERRED EMBODIMENTS

Hereinafter, example embodiments of the present invention will be described in detail with reference to the accompanying drawings.

Regarding the reference numerals assigned to the components in the drawings, it should be noted that the same components will be designated by the same reference numerals, wherever possible, even though they are shown in different drawings. Also, in describing of example embodiments of the present invention, detailed description of well-known related structures or functions will be omitted when it is deemed that such description will cause ambiguous interpretation of the present invention.

Also, to describe components according to example embodiments of the present invention, the terms first, second, A, B, (a), (b), etc. may be used herein. These terms are merely used to distinguish one component from another, but not to imply or suggest the substances, order or sequence of the components. It will be understood that when one component is described as being “connected,” “coupled” or “linked” to another component, it can be directly connected or coupled to the other component, or intervening components may be present.

It will be understood that when a component such as a layer, film, region or substrate is referred to as being placed “on” or “above” another component, it will be understood that the component is placed directly on the other component and that an intervening component may also be present. Also, it will be understood that when a component is referred to as being directly placed “directly on” another component, an intervening component is not present.

A functional sheet according to an example embodiment of the present invention may be formed as a single layer or a composite layer by binding polyolefin staple fibers through needle punching, and may have a plurality of uneven structures formed on at least one surface of the sheet.

Desirably, the functional sheet may be used for various purposes, for example, for waterproofing, soundproofing, ground stabilization, civil engineering, construction and aging-friendly materials, and in particular, may be used for ground stabilization.

The ground stabilization may prevent the ground from being weakened, by inhibiting soil acidification, a soil loss, a ground subsidence, a growth of weeds, and the like, which may occur around farmland, roads such as highways, a national highways and local roads, a sidewalk block and a shoulder of a road, due to weeds, torrential rains, external forces, and the like.

The needle punching may be performed by repetitive vertical motions using needles on surfaces or back surfaces of stable fibers through a needle punching machine so that the stable fibers are mechanically entangled with each other to form a nonwoven fabric having a constant thickness and fiber density.

Hereinafter, a functional sheet according to an example embodiment of the present invention will be further described.

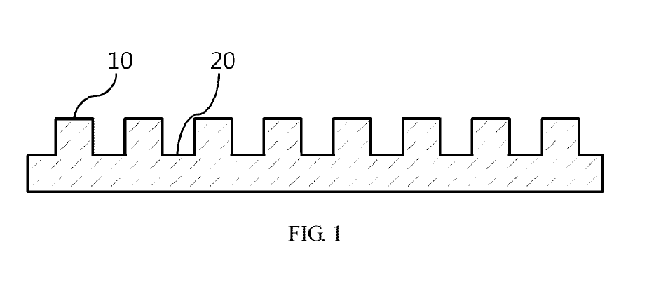

FIG. 1 is a cross-sectional view of a functional sheet according to an example embodiment of the present invention.

The sheet may be, for example, a woven or nonwoven fabric, and desirably be a nonwoven fabric. The nonwoven fabric may desirably be manufactured by needle punching of polyolefin staple fibers.

A polyolefin resin used for the staple fibers may not almost absorb moisture due to a hydrophobicity, and accordingly the durability may be excellent because hydrolysis does not occur even when the polyolefin resin is installed above or below the ground. Since a moisture absorption phenomenon does not occur, a separate drying process is not required in a manufacturing process. The durability of a polyester resin that is widely used for general purposes is reduced due to a promotion of a hydrolysis caused by moisture, and a drying process is necessarily required in a manufacturing process due to a moisture absorption phenomenon. Also, by adjusting the stretching ratio during fiber spinning, properties of the fibers such as the thickness, the strength, and modulus of the fiber may be adjusted. A stretching ratio of the polyolefin resin may be adjusted to be relatively wide in comparison to the polyester resin, and accordingly staple fibers having various properties may be manufactured.

A polyolefin staple fiber used to form the sheet may include, for example, but is not limited to, a polyethylene staple fiber, a polypropylene staple fiber, a polybutylene staple fiber, and the like. Since the polyolefin staple fiber is a type of yarn having an excellent durability despite exposure to sunlight, and the like, the non-woven fabric used as a sheet may be formed by binding polyolefin staple fibers by needle punching in the present invention.

The polyolefin staple fibers may be used to obtain a sheet that is excellent in all required categories: tensile strength, tensile elongation, water permeability, air permeability and durability, due to a synergistic effect with an uneven structure formed on a surface of a sheet that will be described below.

In other words, polyolefin staple fibers may be distributed and bound in a nonwoven fabric used as a sheet, and accordingly air in an atmosphere may easily penetrate into soil through the sheet by a shape and size of a space formed between staple fibers. Also, a surface may be roughly formed due to a difference in a degree of binding of the staple fibers, and accordingly moisture may be easily absorbed onto a surface of the sheet to have an excellent permeability. Due to staple fibers becoming entangled with each other by the needle punching, tensile strength and tensile elongation may increase, and thus it is possible to have excellent durability.

As shown in FIG. 1, a plurality of uneven structures may be formed on at least one surface of the functional sheet.

A difference in height between a convex portion 10 and a neighboring concave portion 20 of an uneven structure may be in a range from 0.5 mm to 8 mm, and desirably in range from 0.5 mm to 5 mm. A top area of a single convex portion 10 may be in a range from 0.5 mm² to 6 mm², and desirably in a range from 1 mm² to 4 mm². The total of the top areas of the convex portions 10 may be from 30% to 70%, desirably from 30% to 60%, of an area of the functional sheet on which the convex portions 10 are formed.

As described above, due to use of polyolefin staple fibers and the uneven structure formed on the surface of the functional sheet, it is possible to obtain a sheet that is excellent in all required categories: tensile strength, tensile elongation, water permeability, air permeability, and durability.

In other words, a surface area of the functional sheet may increase by forming an uneven structure on the surface of the functional sheet, so that air in an atmosphere may easily penetrate into the soil through the sheet and that moisture may be easily absorbed into the surface of the sheet, thereby having an excellent water permeation effect. Also, fiber cohesion of the concave portion may be increased due to the pressure applied to a concave portion of the sheet, so as to have an effect of increasing the tensile strength, the tensile elongation and the durability.

When a difference in height between a convex portion and a neighboring concave portion of an uneven structure is less than 0.5 mm, the effect of increasing the surface area of the sheet may decrease, to lower the effect of enhancing the water permeability and the air permeability. When the difference in height between the convex portion and the neighboring concave portion of the uneven structure exceeds 8 mm, the surface area of the sheet may increase, to enhance the water permeability and the air permeability. However, since the thickness of the concave portion excessively decreases in comparison to the thickness of the convex portion, the effect of enhancing the tensile strength and the tensile elongation may be reduced.

When the top area of a single convex portion is less than 0.5 mm², the surface area of the sheet may be increased, however, the water permeability and the air permeability may be decreased in comparison to the surface area of the sheet, because the convex portions and the concave portions are excessively dense. When the top area of a single convex portion exceeds 6 mm², the effect of increasing the surface area of the sheet may be decreased, to lower the effect of enhancing the water permeability and the air permeability.

When the total of the top areas of all the convex portions is less than 30% of the area of the sheet on which the convex portions are formed, the fiber cohesion of the concave portion may be increased, to increase the tensile force, however, decreasing the water permeability and the air permeability. When the total of the top areas of the convex portions exceeds 70% of the area of the sheet, the water permeability and the air permeability may be increased, however, the fiber cohesion of the concave portion may be decreased to reduce the tensile force.

A convex portion or a concave portion forming the uneven structure may have various shapes, for example, a quadrangular shape, a circular shape, a triangular shape, a “ [symbol] ” shape or a “ [symbol] ” shape, however, there is no limitation thereto. A shape of the convex portion or the concave portion of the uneven structure may be one of the above shapes or a combination of two or more thereof, and may desirably be one of the “ [symbol] ” shape and the “ [symbol] ” shape or a combination thereof. As described above, by forming an uneven structure on a surface of a sheet, it is possible to enhance the water permeability and the air permeability of the sheet, and also possible to enhance the tensile strength, the tensile elongation, and durability. Also, when the convex portion or the concave portion of the uneven structure is formed with a “ [symbol] ” shape or a “ [symbol] ” shape, a fiber cohesion between the convex portion and the concave portion as well as fiber cohesion in the convex portion or the concave portion may be further enhanced, having an effect of further increasing the tensile strength, the tensile elongation and the durability.

Also, a fine valley may be additionally formed on the convex portion or the concave portion forming an uneven structure, and may desirably be formed on the concave portion. When the valley is additionally formed on the concave portion, the water permeability and the air permeability through the concave portions of the sheet may be enhanced, and fiber cohesion in the concave portions may be increased, so as to have an effect of further increasing the tensile strength, the tensile elongation and the durability.

The functional sheet may have a weight per unit area of 30 g/m² to 600 g/m² and desirably 50 g/m² to 500 g/m², and may have a maximum thickness of 0.5 mm to 10 mm and desirably 1 mm to 5 mm.

When the weight per unit area of the sheet is less than 30 g/m², the water permeability and the air permeability may be increased. However, the fiber cohesion of the concave portion may be deceased to reduce the tensile force. When the weight per unit area of the sheet exceeds 600 g/m², the fiber cohesion may be increased to increase the tensile force, however, the water permeability and the air permeability may be decreased.

When the maximum thickness of the sheet is less than 0.5 mm, the sheet may have an excessively high density to increase the fiber cohesion, thereby increasing the tensile force, however, reducing the water permeability and the air permeability. When the maximum thickness of the sheet exceeds 10 mm, the sheet may have an excessively low density for enhancing the water permeability and the air permeability, however, reducing the fiber cohesion, so that the sheet may be easily damaged by an external factor.

The functional sheet according to an example embodiment of the present invention may inhibit a growth of weeds due to high mechanical properties and dense structure of the functional sheet, and may enhance the durability and may prevent subsidence of sidewalk blocks after construction of sidewalk blocks. Also, the functional sheet may allow air to smoothly circulate due to the high water permeability of the functional sheet, to prevent soil acidification and desertification. Thus, the functional sheet may be used as a functional sheet for ground stabilization for matters such as weed growth prevention, civil engineering or construction.

For example, when the functional sheet is used in soil in which crops are planted or a shoulder of a road, a growth of weeds and soil acidification may be inhibited, due to the selective permeability of the functional sheet that allows useful ingredients, such as water, air, liquid fertilizer, and the like, to permeate and that prevents the penetration of weed seeds. In addition, soil loss may be prevented due to the excellent tensile strength and tensile elongation of the functional sheet.

Also, when the functional sheet is used between the ground and a sidewalk block in construction of the sidewalk block, the growth of weeds may be inhibited due to the selective permeability of the functional sheet as described above. Since the functional sheet has an excellent tensile strength and tensile elongation supports the ground and the sidewalk block even though an external force is repeatedly applied onto the sidewalk block, it is possible to prevent any distortion of the sidewalk block and subsidence of the ground. In addition, since the functional sheet supports the ground and the sidewalk block, due to an excellent water permeability, tensile strength and tensile elongation, it is possible to prevent a distortion of the sidewalk block and subsidence of the ground despite torrential rain.

Hereinafter, a method of manufacturing a functional sheet according to an example embodiment of the present invention will be described.

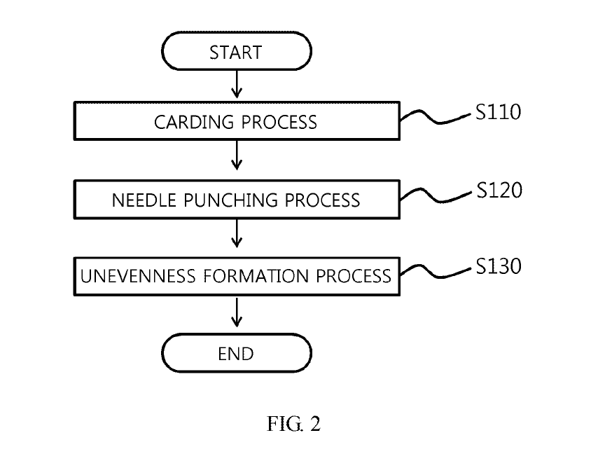

FIG. 2 is a flowchart illustrating a method of manufacturing a functional sheet according to an example embodiment of the present invention. The method of FIG. 2 may include a carding process, a needle punching process and an unevenness formation process.

A carding process 5100 may be a process of forming a web in which staple fibers are oriented in parallel with a plane direction of a non-woven fabric that is to be manufactured. Polyolefin staple fibers may be formed to be oriented in the plane direction of the non-woven fabric, to form a web in which the polyolefin staple fibers are oriented.

To uniformly arrange the staple fibers forming the nonwoven fabric, a blending process of uniformly blending staple fibers may be performed prior to the carding process, although not shown.

In needle punching process 5120, a single-layer or composite layer nonwoven fabric with a constant thickness and fiber density may be formed by mechanically entangling the staple fibers of the web formed through the carding process using a needle punching machine.

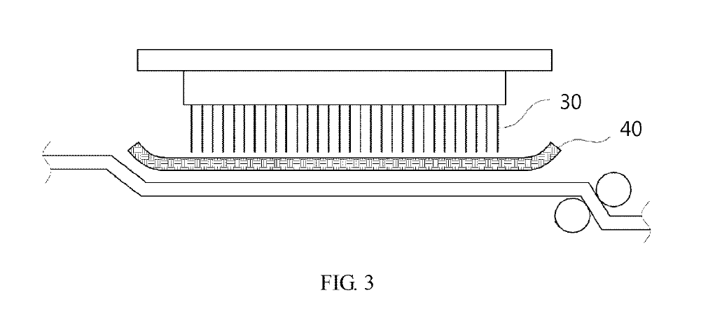

FIG. 3 illustrates a needle punching process in a method of manufacturing a functional sheet according to an example embodiment of the present invention. When a carded web 40 passes through a needle punching machine, staple fibers may be mechanically entangled with each other by punching through surfaces or back surfaces of the staple fibers by a repetitive vertical motions of a plurality of needles 30 in the web 40, so that a non-woven fabric with a constant thickness and fiber density may be formed.

In unevenness formation process 5130, an unevenness, that is, an uneven pattern is formed on the web formed by the needle punching process, that is, on a surface of the nonwoven fabric. By applying heat to the nonwoven fabric while the nonwoven fabric passes through an uneven drum, the cohesion between the staple fibers may be further enhanced.

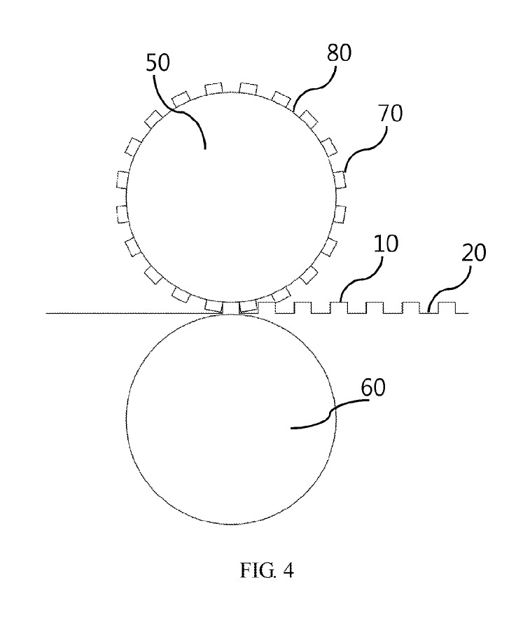

FIG. 4 illustrates an unevenness formation process in a method of manufacturing a functional sheet according to an example embodiment of the present invention. When the non-woven fabric passes through an uneven drum 50 that has an outer circumferential surface on which a plurality of uneven structures are formed and through a flat drum 60 that does not have an uneven structure, an uneven pattern may be formed on the surface of the non-woven fabric. In other words, a concave portion 20 may be formed on a surface of the non-woven fabric that is in contact with a convex portion 70 of the uneven drum, and a convex portion 10 may be formed on a surface of the non-woven fabric that is in contact with a concave portion 80 of the uneven drum. For example, to form a concave portion of the non-woven fabric to have a shape of “ [symbol] ”, a convex portion of the uneven drum may need to have a shape of “ [symbol] ”, in the unevenness formation process. Also, to additionally form a fine valley in a concave portion of the nonwoven fabric, a fine projection needs to be formed in a convex portion of the uneven drum in the unevenness formation process. To form uneven patterns on both surfaces of the non-woven fabric, a combination of uneven drums may be used instead of a combination of the uneven drum and the flat drum.

When an uneven pattern is formed without applying heat to the non-woven fabric in the unevenness formation process, although not shown, a heat treatment process may be additionally performed after the unevenness formation process, to further enhance cohesion between the staple fibers.

While this invention has been particularly shown and described with reference to example embodiments thereof, it will be understood by those skilled in the art that various changes in form and details may be made therein without departing from the spirit and scope of the invention as defined by the appended claims. The example embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A functional sheet formed as a single layer or a composite layer by binding polyolefin staple fibers by needle punching,
wherein the polyolefin staple fibers comprise one selected from a group consisting of a polyethylene staple fiber, a polypropylene staple fiber and a polybutylene staple fiber, and a mixture of two or more thereof.

2. The functional sheet of claim 1, wherein the functional sheet is a sheet for ground stabilization installed above or below a ground.

3. The functional sheet of claim 1, wherein the functional sheet has an uneven structure formed on at least one surface of the function sheet, a top area of a convex portion of the uneven structure is in a range from 0.5 mm² to 6 mm², and a total of top areas of convex portions is 30% to 70% of an area of the functional sheet on which the convex portions are formed.

4. The functional sheet of claim 3, wherein a difference in height between a convex portion and a neighboring concave portion of the uneven structure is in a range from 0.5 mm to 8 mm.

5. The functional sheet of claim 3, wherein a convex portion or a concave portion of the uneven structure has a “ [symbol] ” shape or a “ [symbol] ” shape.

6. The functional sheet of claim 3, wherein a valley is formed in a convex portion or a concave portion of the uneven structure.

7. The functional sheet of claim 1, wherein the functional sheet has a weight per unit area of 30 g/m² to 600 g/m², and a maximum thickness of 0.5 mm to 10 mm.

8. The functional sheet of claim 1, wherein the functional sheet is used for weed growth prevention, soundproofing, waterproofing, civil engineering, construction or aging-friendly materials.
